(19) United States
(12) Patent Application Publication
(10) Pub. No.: US 2005/0128276 A1
(43) Pub. Date: Jun. 16, 2005

(54) Image forming apparatus

(75) Inventor: Takahisa Yamada, Hachioji-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Corporation, Tokyo (JP)

(21) Appl. No.: 11/008,878

(22) Filed: Dec. 10, 2004

(30) Foreign Application Priority Data
Dec. 15, 2003 (JP) 2003-416789

(51) Int. Cl. B41J 2/01

(52) U.S. Cl. 347/104

(57) ABSTRACT

The present invention provides an image forming apparatus in which head units constituted of a plurality of recording heads are arranged adjacent to one another with respect to a conveying direction of a recording medium and in which the head units for colors are arranged together in a short distance in the medium conveying direction, so that a distance between the recording heads is shortened as compared with a conventional apparatus and color difference is minimized with respect to an equal skewing amount of the recording medium.

### CROSS-REFERENCE TO RELATED APPLICATIONS

This application is based upon and claims the benefit of priority from prior Japanese Patent Application No. 2003-416789, filed Dec. 15, 2003, the entire contents of which are incorporated herein by reference.

### BACKGROUND OF THE INVENTION

1. Field of the Invention

The present invention relates to an image forming apparatus which discharges ink to a conveyed recording medium to thereby form an image.

2. Description of the Related Art

In general, an image forming apparatus to which a plurality of recording heads are fixed and which discharges four different colors (e.g., B: black, C: cyan, M: magenta, Y: yellow) of ink with respect to a conveyed recording medium (e.g., recording paper) to form a color image, a so-called ink jet type image forming apparatus has been known. A nozzle row of a plurality of nozzles arranged in one row is formed in this recording head in such a manner as to have a length which is not less than a width of the recording medium. Additionally, a plurality of recording heads having nozzle rows having a length shorter than the recording medium width are used, and connected to one another in such a manner as to have overlap portions on opposite sides in a direction (sub-scanning direction) crossing a conveying direction (main scanning direction) of the recording medium at right angles, and an image can be formed/finished by apparently one nozzle row.

For example, in Jpn. Pat. Appln. KOKAI Publication No. 2003-11377, an image forming apparatus is described on which four recording heads (referred to, e.g., as line heads) provided with one nozzle row not shorter than the width of the recording medium are mounted and which discharges different colors of ink. The nozzle row of this recording head is arranged along the sub-scanning direction. A constitution example is also described in which a plurality of recording heads are alternately arranged along the sub-scanning direction in such a manner as to have the overlap portions of the nozzle rows.

In these recording heads, an annular conveying belt constituting a conveying mechanism (belt platen) of the recording medium is extended between at least two rollers, and the recording heads are arranged in such a manner that nozzle surfaces (surfaces on which the nozzle rows are formed) of the recording heads are arranged facing the rotating conveying belt.

In the recording head of an ink jet system, ink sticks to the nozzle and solidifies, accordingly an ink discharge port is clogged, and therefore maintenance needs to be periodically performed. Therefore, a movable maintenance unit is disposed in the recording head. The maintenance unit comprises a protection unit which closely sticks to the nozzle surface of the recording head and occludes the surface from the outside to protect the recording head from the solidifying ink, sticking dust or the like when not used, that is, when any image is not formed.

In the above-described conventional image forming apparatus, an interval between the recording medium conveying surface and the nozzle (ink discharge port) in the belt platen is set to about 1 mm at the time of image formation. Therefore, at a maintenance or protection time, the recording head is raised, or the belt platen is lowered to expand this gap, and the maintenance unit is disposed facing the nozzle surface in the vicinity of the nozzle surface.

Then, as described in Jpn. Pat. Appln. KOKAI Publication No. 2003-11377, the maintenance units are alternately arranged facing the conveying surface of the recording medium between the recording heads in such a manner as to minimize a movement amount of the recording head or the maintenance unit.

### BRIEF SUMMARY OF THE INVENTION

According to the present invention, there is provided an image forming apparatus in which a plurality of recording heads are arranged in the vicinity of one another, and a maintenance unit is disposed in the vicinity of these recording heads in accordance with the arrangement of the recording heads, so that color difference in color image formation is prevented, sufficient maintenance is realized, and an image is stably formed.

According to the present invention, there is provided an image forming apparatus comprising: image forming means of an ink jet system; medium holding/conveying means disposed facing the image forming means to support a recording medium; and maintenance means for maintaining an ink discharge surface of the image forming means, wherein the ink discharge surface of the image forming means and at least a part of the maintenance means are disposed facing the medium holding/conveying means, and the maintenance means is disposed on an upstream side of the image forming means in a conveying direction.

### BRIEF DESCRIPTION OF THE SEVERAL VIEWS OF THE DRAWING

FIG. 1 is a diagram showing a schematic constitution example of an image forming apparatus according to a first embodiment of the present invention;

FIG. 2 is a diagram showing a constitution example of a belt platen unit in the first embodiment;

FIG. 3 is a diagram showing a schematic constitution example of a recording head;

FIG. 4 is a diagram schematically showing an ink channel in the image forming apparatus of the present invention;

FIG. 5 is a diagram showing an appearance constitution of a suction section and a cap section in a maintenance unit in the first embodiment;

FIG. 6 is a diagram showing a sectional constitution of an oil pan in the first embodiment;

FIG. 7 is a diagram showing an arrangement example of the recording head and maintenance unit in the first embodiment;

FIG. 8 is a diagram showing an inner constitution example in the image forming apparatus of the present invention;

FIG. 9 is a diagram showing one example of an image in which color difference is not generated;

FIG. 10 is a diagram showing a schematic constitution example of the image forming apparatus according to a second embodiment of the present invention;

FIG. 11 is a diagram showing an arrangement example of the recording head and maintenance unit in a conventional constitution;

FIG. 12 is a diagram showing one example of an image in which the color difference is generated; and

FIG. 13 is a diagram showing a constitution example of an image forming apparatus according to a third embodiment of the present invention.

### DETAILED DESCRIPTION OF THE INVENTION

Embodiments of the present invention will be described hereinafter in detail with reference to the drawings.

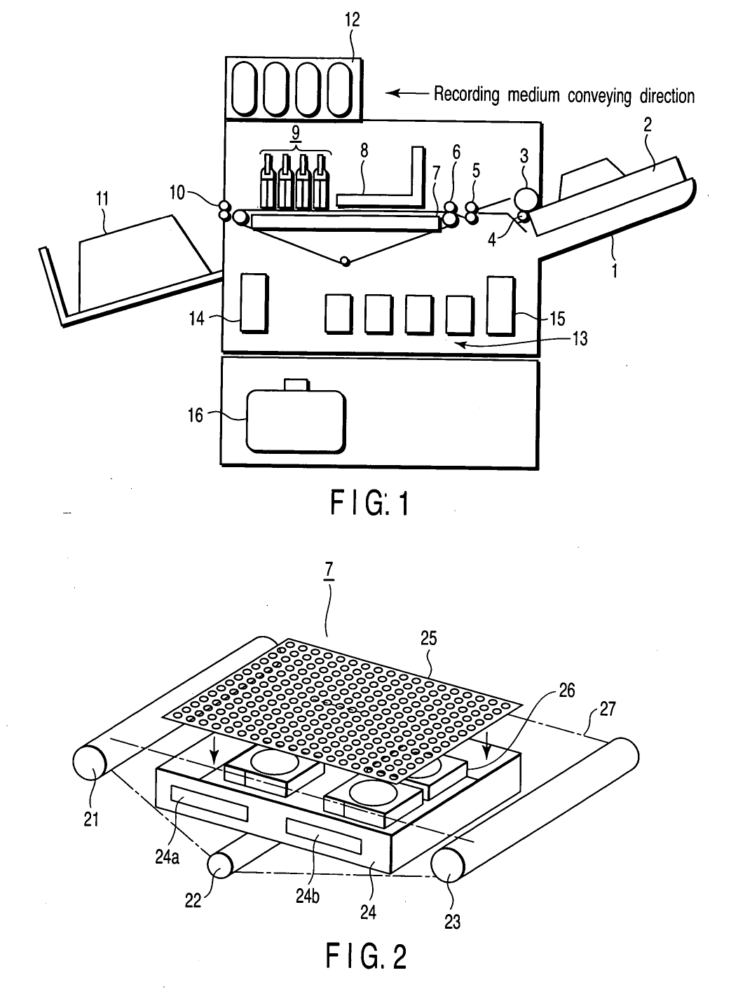

FIG. 1 shows a schematic constitution example of an image forming apparatus according to a first embodiment of the present invention. The example will be described. In the following embodiment, it is assumed that a conveying direction of a recording medium is an X-axis direction or a main scanning direction, and a direction crossing the conveying direction is a Y-axis direction or a sub-scanning direction.

This image forming apparatus is an image forming apparatus of a so-called ink jet system, in which a plurality of recording heads are fixed, and discharge four different colors (e.g., B: black, C: cyan, M: magenta, Y: yellow) of ink to thereby form a color image onto a conveyed recording medium such as recording paper.

This image forming apparatus roughly comprises: a medium supplying/discharging mechanism which supplies or discharges a recording medium; a conveying mechanism which conveys the recording medium; an image forming mechanism which discharges ink onto the recording medium to thereby form an image; an ink supplying/storing mechanism which supplies or stores the ink; and a maintenance mechanism which maintains the recording heads.

First, the medium supplying/discharging mechanism comprises: a recording medium supply base 1 on which a recording medium 2 is to be charged; a supply roller 3 which supplies/feeds the recording medium 2; a separation roller 4 which prevents superimposition of the recording mediums 2; a resist roller pair 5 which corrects skewing of the recording medium 2; a discharge roller pair 10 which discharges the recording medium 2; and a discharge tray 11 which stores the discharged recording medium.

In this constitution, the supply roller 3 is disposed in a take-out port of the recording medium supply base 1 onto which the recording medium 2 is charged, and abuts on the uppermost surface of the recording medium 2 to take out and supply/feed the recording medium 2. The separation roller 4 abuts on the back surface of the taken recording medium 2 to rotate the recording medium 2 in a returning direction toward the recording medium supply base 1 via a torque limiter (not shown) in such a manner as to prevent the taken recording mediums 2 from being superimposed on each other. The resist roller pair 5 brings a tip of the recording medium 2 into contact with the stopped roller pair, and corrects the skewing utilizing looseness generated at this time, while feeding the recording medium 2 on the side of the conveying mechanism.

Next, the conveying mechanism mainly comprises a belt platen unit 7 and a platen vertical movement mechanism (not shown). In this belt platen unit 7, as shown in FIG. 2, a case formed of a box-shaped sheet metal is sealed by a platen 25 which is formed of an aluminum plate having a thickness of about 5 mm and in which a large number of through holes are made from above the case to thereby constitute a suction chamber 24. A plurality of suction fans 26 for setting pressure in the suction chamber to be negative are attached to a bottom part in the suction chamber 24. Discharge ports 24a, 24b for discharging exhaust air from the suction fans 26 are disposed in one side surface of the case.

Moreover, a driving roller 21, a driven roller 23, and a tension roller 22 are disposed on an upstream side, on a downstream side, and under the conveying direction of the suction chamber 24, and a belt 27 is rotatably attached in such a manner as to surround the rollers. The belt 27 has a structure which passes air, for example, a structure in which a large number of suction holes are formed. While tension is imparted by the tension roller 22, the belt is rotated by the driving roller 21 in a contact state with respect to the surface of the platen 25. By this structure, the recording medium is adsorbed on the side of the platen 25 together with the belt 27 by the suction fans 26, and can be conveyed.

As shown in FIG. 1, the image forming mechanism is constituted of four head units 9 having a plurality of ink jet system recording heads, arranged facing the belt platen unit 7 (belt conveying surface). These recording heads discharge four different colors of ink for each head unit 9.

Moreover, in the maintenance mechanism, a maintenance unit 8 is disposed facing the belt conveying surface in the same manner as in the head unit 9. Therefore, the maintenance unit is disposed on the upstream side of the conveying direction, and the head unit 9 is disposed on the downstream side thereof.

The ink supplying/storing mechanism mainly comprises: a plurality of bottles 12 in which four colors of ink are charged; sub-tanks 13 constituting tanks for supplying the ink to the recording heads from the bottles 12; a suction pump 15 which sucks unnecessary ink; and a waste liquid bottle 16 which collects and stores the unnecessary ink.

The bottles 12 are arranged as bottles 12K to 12Y described later in which the four colors of ink are charged in a highest position in the ink channel in an upper part of an image forming apparatus main body. The bottles 12 are connected to the sub-tanks 13 via replenishment paths (not shown). The ink which has overflowed the sub-tank 13 is stored in the waste liquid bottle 16 by the suction pump 15.

The respective constituting components will be described hereinafter in detail.

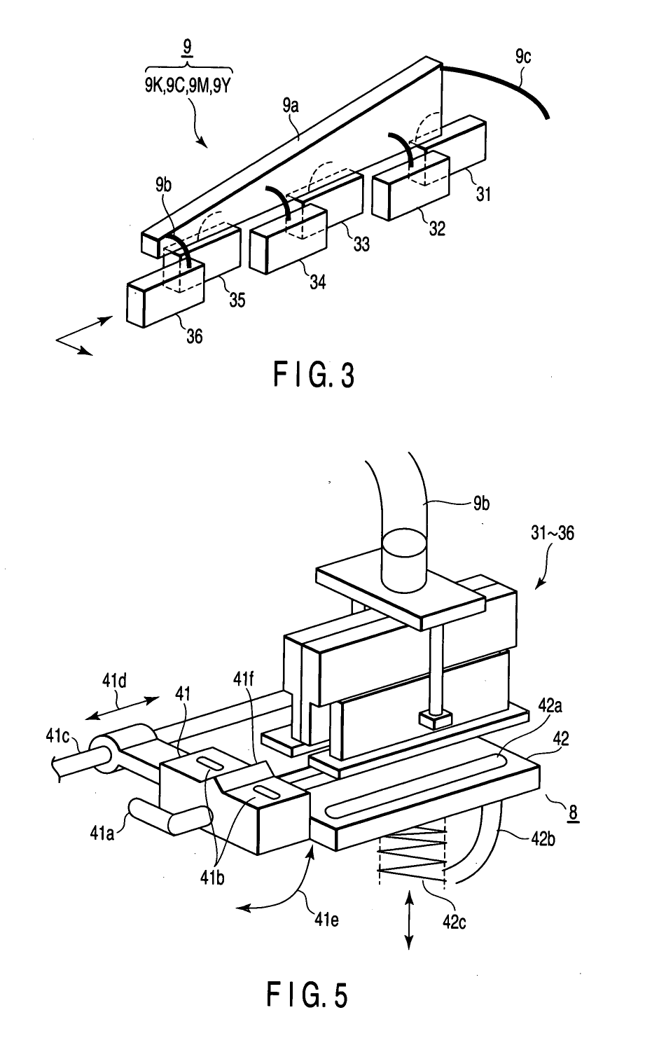

First, a constitution of the head unit 9 will be described with reference to FIG. 3.

In recording heads 31 to 36, about 636 nozzles (not shown) are arranged in one nozzle row or two nozzle rows at a density of 300 dpi (interval or 84.6 μm) in a direction (sub-scanning direction) crossing a medium conveying direction (main scanning direction) at right angles. A surface on which this nozzle row is disposed is hereinafter referred to as a nozzle surface.

These recording heads 31 to 36 are alternately arranged along the sub-scanning direction. The recording heads are arranged in the medium conveying direction in such a manner that opposite ends of the nozzle row are superimposed (additionally, one end of the recording head 31 or 36 is superimposed). A discharge timing at which the ink is discharged for each recording head is, needless to say, adjustable. By this arrangement, apparently the recording heads 31 to 36 form the image as if the recording heads had one nozzle row having a nozzle pitch of 300 dpi and a nozzle number of about 3816. Therefore, even if the nozzles are arranged in a plurality of rows with respect to the medium conveying direction, one straight line can be formed in the sub-scanning direction (lateral direction) on the recording medium 2 by adjustment of the discharge timing.

As shown in FIG. 3, these recording heads 31 to 36 are connected to an ink distributor 9a via tubes 9b. The ink is replenished to this ink distributor 9a from the sub-tank 13 via a tube 9c. This ink distributor 9a is planar, and has an ink channel therein, and an upper part of the ink distributor has a tilt gradient. This is because bubbles generated inside are collected in a highest position, and entrance of the bubbles into the nozzles is prevented. The recording heads 31 to 36 are connected to a control substrate via individual wirings (not shown).

Moreover, the nozzle surfaces in which the nozzles of the respective recording heads 31 to 36 are formed are arranged facing the belt 27 in such a manner as to obtain an interval of about 1 mm from the belt surface. Correctly, a distance from the recording medium adsorbed and conveyed by the belt 27 is set to about 1 mm. These recording heads 31 to 36 and the ink distributor 9a which supplies the ink to these heads constitute the head unit 9 (9K, 9C, 9M, 9Y). The head unit 9 is divided into units of the respective colors. Here, black ink is charged in a head unit 9K, cyan ink is similarly charged in a head unit 9C, magenta ink is charged in a head unit 9M, and yellow ink is charged in a head unit 9Y.

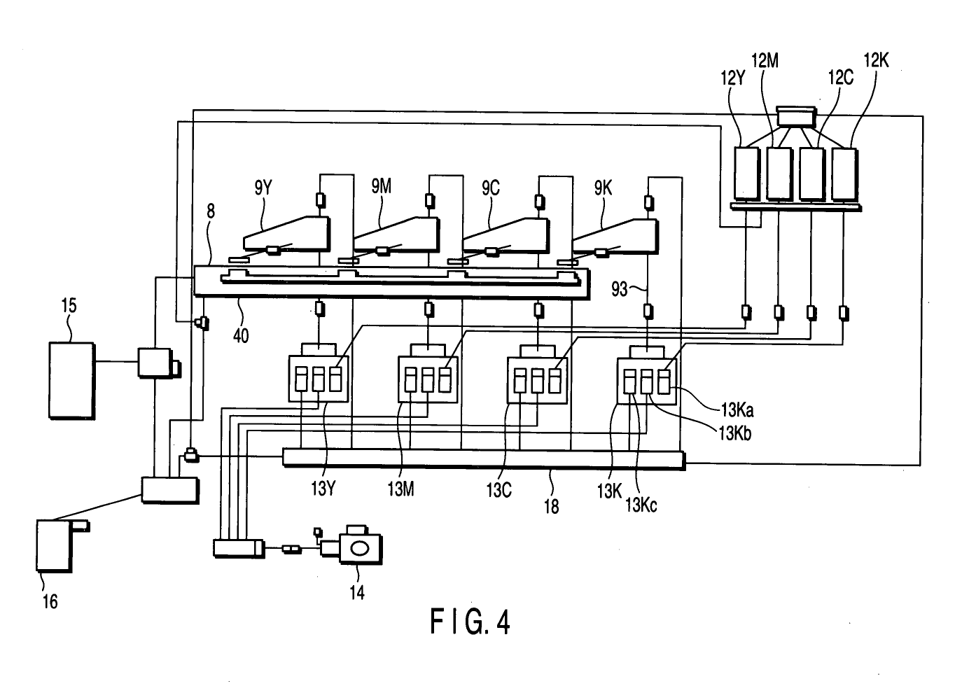

FIG. 4 schematically shows an ink channel in the image forming apparatus of the present invention. Next, the ink channel will be described.

In this apparatus, the respective colors of ink are charged in four bottles 12K to 12Y, and the bottles are attached to highest positions in the ink channel. Black will be described in accordance with an example of one system of the ink. The replenishment path is connected to a sub-tank 13K from the bottle 12K via an electromagnetic valve 13Ka. A tube for releasing the inside to the atmosphere is extended from a top part of the sub-tank 13K, and the sub-tank is connected to an overflow tank 18 via an atmosphere release magnetic valve 13Kc. As shown in FIG. 1, a pressurizing pump 14 is disposed in the apparatus, and connected to the sub-tank 13K via the electromagnetic valve 13Kc.

Moreover, a liquid suction port is disposed in the sub-tank 13K in such a manner as to pump up accumulated black ink from a bottom part, and connected to the ink distributor 9a of the head unit 9K by a replenishment tube 93. A liquid level detection sensor (not shown) is disposed in the sub-tank 13. When a liquid level drops, the electromagnetic valve 13Ka is opened, and the ink is replenished to the sub-tank 13K from the bottle 12K by an ink weight. A cap section 42 and a suction section 41 are prepared for each of head units 9K to 9Y. The overflow tank 18 for receiving the ink which has overflowed the sub-tank 13, an ink pan 40, and the suction pump 15 are connected to the waste liquid bottle 16, and the finally unnecessary ink is stored in the waste liquid bottle 16.

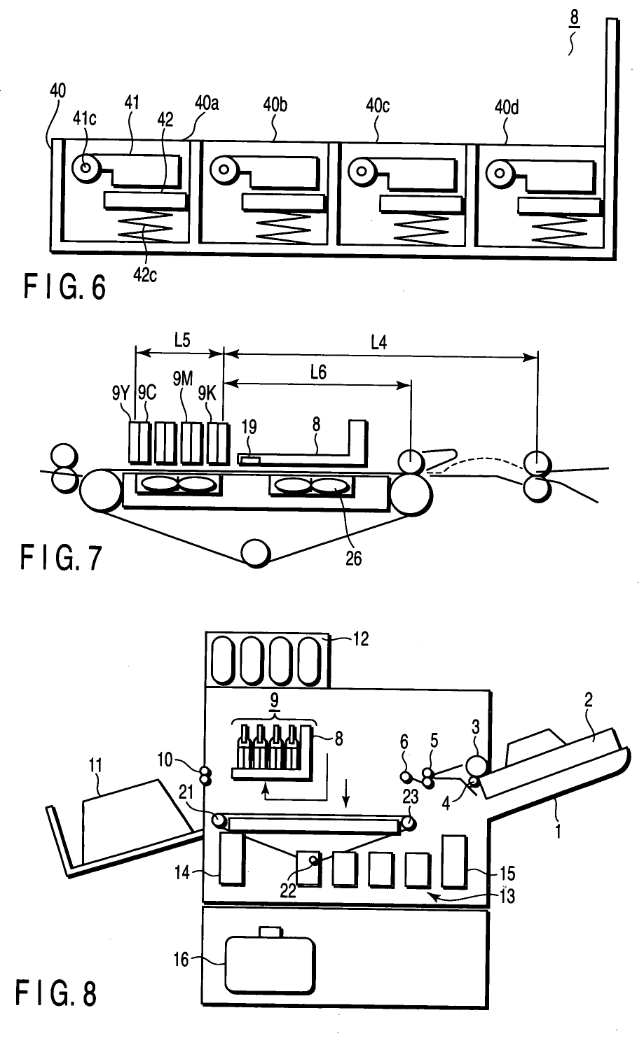

Next, the maintenance unit will be described with reference to FIGS. 5 and 6. Here, FIG. 5 shows an appearance constitution of the suction section and cap section in the maintenance unit, and FIG. 6 is a diagram showing a sectional constitution of an oil pan.

The maintenance unit 8 comprises the box-shaped ink pan 40 divided into a plurality of chambers 40a to 40d by walls in such a manner as to prevent the overflow of the ink in the apparatus, and maintenance sections disposed in the respective chambers 40a to 40d to maintain or protect the nozzle surfaces of the recording heads 31 to 36. In the present embodiment, since the maintenance unit is assigned to each recording head, the chambers are disposed as many as the recording heads. Needless to say, the present invention is not limited to this embodiment. When one maintenance unit takes charge of the maintenance of a plurality of recording heads, the corresponding number of the chambers are disposed.

In each of the chambers 40a to 40d, an annular guide portion 41c is disposed in a direction crossing the medium conveying direction at right angles, and the guide portion 41c is fitted and attached in such a manner as to be slidable in a direction of an arrow 41d (sub-scanning direction).

These suction sections 41 face the nozzle surfaces of the recording heads 31 to 36, and suction ports 41b for sucking surplus ink which has dropped from each nozzle are disposed in the suction sections. The suction pump 15 which applies a pressure (negative pressure) for suction from the suction ports 41b is connected to a convex pipe port 41a disposed in the side surface of the suction section 41 by a tube.

This suction section 41 is moved along the guide portion 41c in the sub-scanning direction by the driving mechanism (not shown). Moreover, the suction section is rotatable in an arrow 41e direction, and moved in the arrow 41d direction while a triangular guide portion 41f on the upper surface is pressed against an edge of each of the recording heads 31 to 36. By this movement, the suction ports 41b of the suction section 41 are moved along the nozzle row, facing the nozzles, and the suction is possible in this state. It is to be noted that the suction ports 41b are prevented from being brought into contact with the nozzle surface by the triangular guide portion 41f.

Moreover, the cap section 42 is vertically movably disposed facing under the nozzle surfaces of the recording heads 31 to 36. The cap section 42 is formed, for example, of an elastic member such as rubber or resin, and a groove 42a which is a concave portion is formed only in a portion facing the nozzles of each of the recording heads 31 to 36. A hole is made in a bottom part of the groove 42a, and connected to a pipe 42b, and the ink accumulated in the groove 42a is discharged to the outside. This cap section 42 is controlled in such a manner as to be attachable/detachable with respect to the recording heads 31 to 36 by an attaching/detaching mechanism (not shown). Furthermore, the cap section 42 is urged in such a manner as to be pressed by a spring 42c, when abutting on the recording heads 31 to 36. It is to be noted that the suction section 41 moves among the recording heads 31 to 36 in a state in which the cap section 42 is detached from the recording heads 31 to 36 to thereby suck the surplus ink sticking to the nozzle surfaces.

Moreover, in the present embodiment, it has been described that the suction section 41 is a section separate from the cap section 42 in the maintenance unit, but the present invention is not limited to this embodiment. For example, the suction section 41 may be disposed in the cap section 42 to thereby constitute a maintenance device of such a type that the ink is sucked from the nozzle, when the cap section abuts on the nozzle section.

As shown in FIG. 1, the maintenance unit 8 of the present embodiment is disposed facing the belt 27 on the upstream side of the medium conveying direction of the head units 9K to 9Y. Since the respective head units 9K to 9Y are arranged adjacent to one another, as shown in FIG. 7, a distance L5 is formed. On the other hand, as shown in FIG. 11, the head unit 9 (9K to 9Y) has heretofore had a distance L2, and the distance between the recording heads in the present embodiment is shorter.

Moreover, in the conventional constitution shown in FIG. 11, an auxiliary roller 6 abuts on the roller 23 via a belt by its own weight. There has heretofore been a distance L3 from the auxiliary roller 6 to the first head unit 9K, but there is a distance L6 in the present embodiment, and the distance largely lengthens.

As to this distance, in the conventional constitution shown in FIG. 11, the recording medium needs to be brought into close contact with the belt immediately after the tip of the recording medium rides on the belt. Additionally, at this time, most of suction holes disposed in the belt are not closed. This constitution requires a strong suction force also in a top portion of the belt on the upstream side in order to prevent the recording medium abutting on the belt from being shifted or floated. A large number of suction fans are required, and the suction fan is also disposed on the upstream side.

On the other hand, in the present embodiment, as shown in FIG. 7, the maintenance unit is disposed on the upstream side of the head units 9K to 9Y. Therefore, the recording medium passes under the maintenance unit 8, and reaches the first head unit 9K. The lower surface of the maintenance unit can be disposed in a position apart from the head with respect to the belt 27. Concretely, the lower surface is disposed apart from the belt by 5 mm.

That is, even if the recording medium slightly floats up, the medium can pass under the maintenance unit 8, and any paper is not jammed. Thereafter, the half of the suction holes made in the belt 27 are closed by the recording medium until the recording medium reaches the head unit 9K. An internal pressure of the chamber is maintained to be high, and even the tip portion of the recording medium completely closely adheres to the belt 27. Therefore, the number of the suction fans can be reduced as compared with the conventional constitution.

The image formation in the image forming apparatus constituted in this manner will be described.

First, the recording medium 2 supplied from the recording medium supply base 1 is supplied/fed by the supply roller 3, separated into one sheet by the separation roller 4, and abuts on the resist roller pair 5. The sheet is supplied again from the resist roller pair 5 at a taken timing, and the tip thereof is nipped and conveyed between the auxiliary roller 6 and the belt 27. At this time, a conveying speed of the resist roller pair is set to be lower than that of a medium conveying speed by the supply roller 3 by 1%. Furthermore, the conveying speed by the belt 27 is set to be lower than that of the resist roller pair 5 by 1%. The medium tip which has ridden on the belt 27 is adsorbed by the belt 27 by a suction force (negative pressure) generated by the suction fan 26.

The medium tip held between the belt 27 and the auxiliary roller 6 is not sufficiently adsorbed by the belt 27, but is securely adsorbed as the medium advances toward the head unit 9K. Immediately after the sheet tip is held between the auxiliary roller 6 and the belt 27, the sheet moves at the conveying speed of the resist roller pair 5. However, as the sheet is securely adsorbed by the belt 27, the sheet is conveyed at a speed equal to the conveying speed of the belt 27.

In the present embodiment, the head units 9K to 9Y are arranged adjacent to one another, and the maintenance unit 8 is disposed facing the belt platen unit on the upstream side of the head unit. Accordingly, while the sheet tip passes under the maintenance unit 8, the conveying speed is stabilized in accordance with the speed of the belt 27. Since the sheet securely closely adheres to the belt 27, the float-up is eliminated, and the contact with the head unit 9K is prevented.

The recording medium 2 nipped between the auxiliary roller 6 and the belt 27 is adsorbed by the belt 27 by the negative pressure in a suction chamber, and passes under the head unit 9. In this case, a change of the position of the recording medium 2 is read by a line sensor (CCD) disposed immediately after the auxiliary roller 6, and the ink discharge from the nozzle is controlled. Concretely, the timing at which the medium tip passes under each head unit 9 is calculated, and controlled in such a manner as to match a discharge start timing. A change of the position of a side-surface end of the recording medium is read, a medium position in a lower part of each head unit 9 is predicted, and a mask process is performed in such a manner as to prevent the ink from being discharged to a portion other than the recording medium.

Moreover, after reaching the portion under the head unit 9K, the conveyed recording medium 2 successively takes the timing in 9C, 9M, 9Y to thereby form an image. It is to be noted that as to a reference of this timing, an encoder (not shown) is disposed in the belt platen unit, and a pulse signal generated in accordance with the movement amount of the belt is used. Since the conveying speed of the recording medium 2 is constant by this conveyance, the color difference of the image formed in each color can be minimized.

Thereafter, the recording medium 2 on which the image has been formed is discharged by the discharge roller pair 10, and stored in the discharge tray 11.

The conveying direction sometimes slightly differs in the above-described conveyance of the recording medium 2. This is a phenomenon referred to as so-called skewing, in which a length direction of the recording medium 2 does not match the conveying direction, and is oblique. That is, the medium is not constantly conveyed in a direction crossing the sub-scanning direction of the head unit 9 at right angles. The medium is conveyed in a slightly different direction by eccentricity of the head unit 9 or a conveying direction error with respect to the belt 27.

The color difference by the skewing will be described.

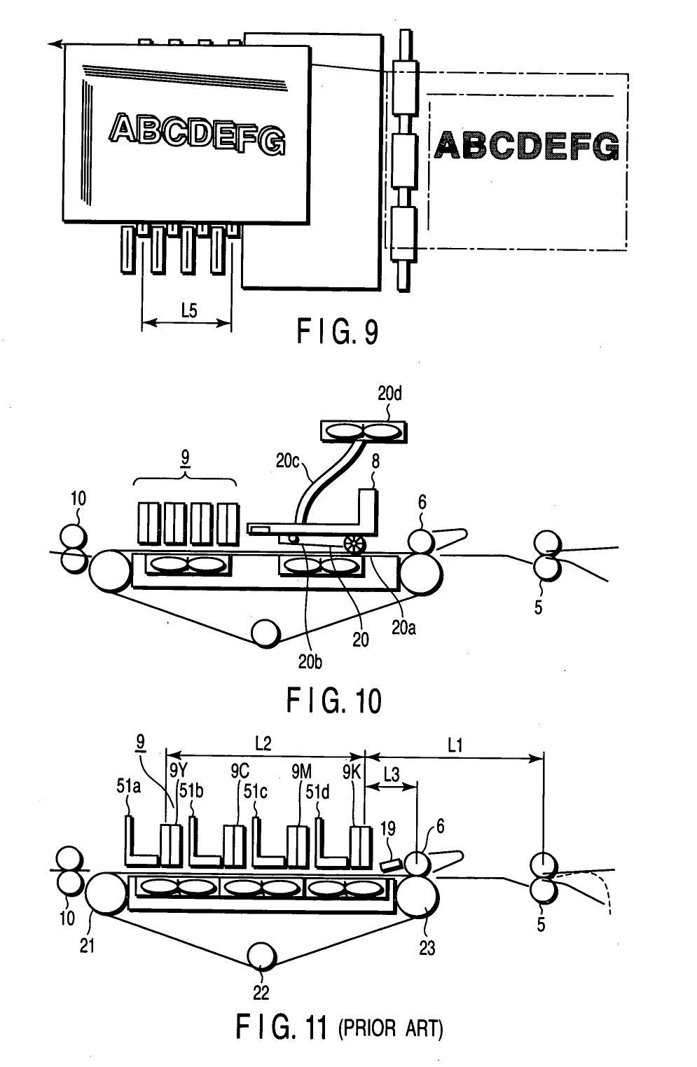

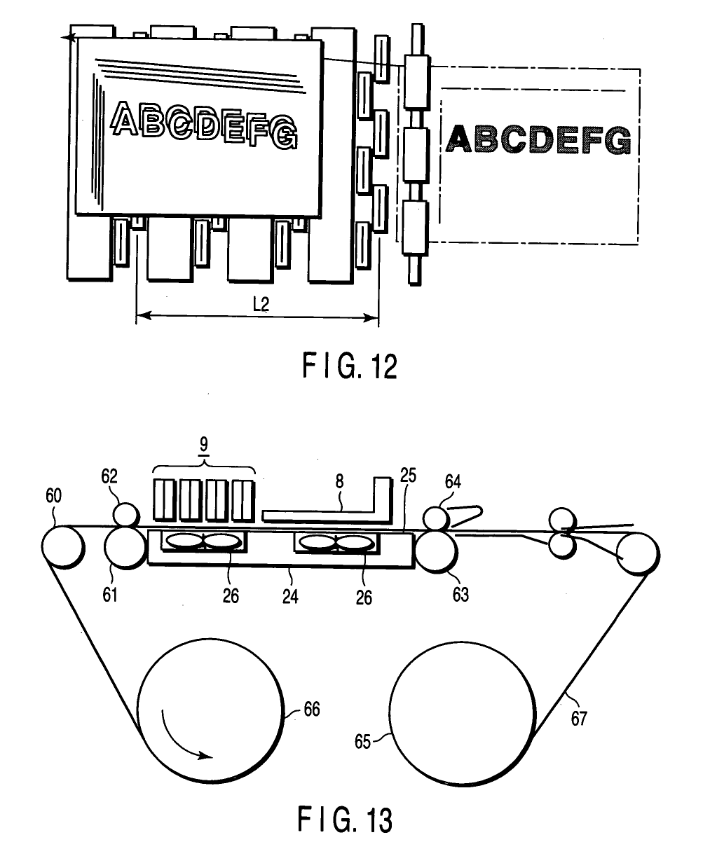

FIG. 9 shows a state in which any color difference is not generated, and FIG. 12 shows a state in which the color difference is generated by the skewing. That is, in comparison of the conventional distance L2 between the head units 9K and 9Y shown in FIG. 11 with the distance L5 between the head units 9K and 9Y of the present embodiment, the distance L5 in the present embodiment is shorter than the distance L2. Therefore, as apparently seen from comparison of FIG. 9 with FIG. 12, in the present embodiment, the color difference is minimized with respect to an equal skewing amount of the recording medium.

Next, a sensor (line sensor) which detects a tip portion of the recording medium will be described.

A sensor 19 for detecting the conveyed sheet tip is disposed in the vicinity of the head unit 9K on the upstream side. The sensor 19 is a line sensor which is capable of detecting the sheet tip over the width of the belt 27 and which optically detects the medium tip in a non-contact state, such as a CCD sensor. The medium tip supplied again by the resist roller pair 5 is captured by the sensor 19, and the discharge by each of the head units 9K to 9Y is controlled at a predetermined timing detected by the encoder or the like based on the signal.

In the present embodiment, the maintenance unit 8 is disposed on the upstream side of the head units 9K to 9Y, and the sensor 19 detects the recording medium 2 conveyed at a speed equal to that of the belt 27 in a state in which the recording medium 2 sufficiently adheres to the belt 27. Therefore, any scattering does not occur in a recording start position in the head units 9K to 9Y, and the color difference in each color can be reduced.

The sensor 19 is disposed facing the belt 27 on the lower surface of the maintenance unit 8. This position is preferably disposed in the vicinity of the head unit 9, and is preferably on the downstream side in the lower surface of the maintenance unit facing the belt. Alternatively, the sensor may be disposed facing the belt 27 between the maintenance unit 8 and the head unit 9K.

Next, powder dust (e.g., paper powder) generated in a case where the recording medium is paper (recording sheet) will be described with reference to FIG. 7.

When the paper is used as the recording medium 2 in the conventional apparatus, the paper powder is generated by friction at a cutting time, by the supply roller 3, or by separation roller 4. The paper powder sticks to the recording sheet, and moves, but leaves the recording sheet because of a rapid posture change in abutting on the resist roller pair 5 to form a loop (broken line shown in FIG. 11), and flies in the atmosphere.

Furthermore, a loop (broken line shown in FIG. 7) is formed between the auxiliary roller 6 and the resist roller pair 5 by a difference between the conveying speed by the belt 27 and that of the resist roller pair 5 until a recording sheet rear end leaves the resist roller pair 5. Moreover, the paper powder sticking to the recording sheet flies in the atmosphere also because of a rapid posture change at the moment at which the sheet leaves the resist roller pair 5.

The flying paper powder moves downstream together with the recording sheet by air viscosity on the recording sheet surface, and reaches the head unit 9. Here, when the powder sticks to the nozzle of the head unit 9, discharge defects are generated, and cause nozzle clogging.

In the present embodiment, the head units 9K to 9Y of the respective colors are arranged adjacent to one another together in the conveying direction. Moreover, the maintenance unit 8 is disposed on the upstream side of the head unit. Accordingly, as to the distance from the auxiliary roller 6 or the resist roller pair 5 to the head unit 9, the distances L1, L3 shown in the prior art of FIG. 11 can be expanded to the distances L4, L6 shown in the present embodiment of FIG. 7.

Therefore, a probability increases that the paper powder generated on the upstream side from the auxiliary roller 6 is sucked via the hole in the belt by the function of the suction fan 26 until the powder reaches the head unit 9K, the adhering to the head unit 9 is prevented, and further the generation of the discharge defects can be prevented.

Next, a recovery operation in a case where the dust sticks to the nozzle surface of the head unit 9 or the nozzle is clogged will be described.

To perform the recovery operation, the ink which has dropped from the nozzle needs to be prevented from being attached to the belt 27 or the platen 25. As shown in FIG. 1 or 8, a vertical movement mechanism (not shown) is disposed in the belt platen unit 7, and the belt platen unit 7 is lowered and retracted from a facing position with respect to the head unit 9 at a recovery operation time.

A space is generated by this retraction, and the maintenance unit 8 once moves down from the head unit 9, and moves to the position facing the nozzle surface on the downstream side of the medium conveying direction (main scanning direction). Next, the unit rises to a predetermined height in the facing position. A mechanism in which the belt platen unit 7 vertically moves may be utilized as a movement mechanism in which the cap section 42 contacts/leaves the head unit 9. For example, the maintenance unit 8 is disposed on the belt platen unit 7, and the belt platen unit 7 is raised. Accordingly, the cap section 42 is raised to abut on the head unit 9.

Moreover, when the height for raising the maintenance unit 8 is changed, the position where the triangular guide portion 41f of the suction section 41 abuts on the head unit 9, and the position where the cap section 42 abuts can be selectively used.

The recovery operation is performed at a height at which the triangular guide portion 41f of the suction section 41 abuts on the head unit 9 to bring the suction ports 41b close to and facing the nozzle surface. The electromagnetic valves 13Ka, 13Kb are closed, and the electromagnetic valve 13Kc is opened in order to transmit the pressure of the pressurizing pump 14 to the sub-tank. The ink is pushed out of the sub-tank by this operation, and reaches the ink distributor 9a. The ink is pushed out of the nozzle of the head unit 9, and recovery is performed.

As a result, the dust which has adhered to the nozzle and its vicinity is pushed away. Since the surplus ink adheres to the nozzle portion or the nozzle surface, the suction section 41 is moved from end to end of the nozzle surface of the head unit 9 while sucking the ink. The ink sucked by the suction section 41 or the ink dropped inside the ink pan 40 is collected in the waste liquid bottle 16.

Next, a capping operation with respect to the recording heads by the cap section 42 will be described.

This capping operation is different from the recovery operation in that the cap section 42 is closely attached to the head unit 9 by an elastic force by the spring 42c. When the maintenance unit 8 is raised, the cap section 42 can be closely attached to the head unit 9 by an urging force of the spring 42c. This is because the cap section is formed of a rubber or the like having elasticity.

Additionally, since the groove 42a is disposed in the cap section facing the nozzle, the nozzle does not directly contact the cap section 42. This capping operation occludes the nozzle from the outside air, and prevents the ink from being evaporated and solidified in the nozzle. The dust from the outside is also prevented from being attached.

Furthermore, when the sheet is jammed in a platen portion, the belt platen unit 7 lowers, and the jammed recording medium can be removed. When the hand is inserted between the head unit 9 and the belt 27, the nozzle of the head unit 9 can be prevented from being damaged because of operator's carelessness. This is because the maintenance unit 8 moves to a position facing the head unit 9 to achieve a capped state.

According to the first embodiment described above, the following function/effect can be obtained.

(1) The head units (or the recording heads) of the respective colors are arranged adjacent to one another in the conveying direction, and these head units are arranged together in the short distance in the medium conveying direction. Therefore, the distance between the recording heads is shorter as compared with the conventional constitution, and the color difference can be minimized with respect to a predetermined skewing amount of the recording medium.

(2) The maintenance unit is disposed on the upstream side of the head unit of each color, and the units are arranged in such a manner as to face the conveying surface of the conveying belt. Accordingly, the recording medium can closely adhere to the belt until reaching the first head unit (recording head). The sheet jam can be prevented.

(3) The maintenance unit is disposed on the upstream side of the head unit of each color, and the units are arranged in such a manner as to face the conveying surface of the conveying belt. Accordingly, the half of the suction holes in the belt are closed until the recording medium reaches the first head unit (recording head). The adsorption is possible by a weaker suction force as compared with the conventional constitution, and the suction fans can be reduced.

(4) The maintenance unit is disposed on the upstream side of the head unit of each color, and the units are arranged in such a manner as to face the conveying surface of the conveying belt. Accordingly, the recording medium can closely adhere to the belt until reaching the first head unit (recording head). The recording medium sufficiently follows the conveying speed of the belt, and reaches each head unit. Therefore, speed fluctuation of the recording medium is little from when the image formation starts, and recording timing shift (color difference) in the conveying direction can be minimized.

(5) The maintenance unit is disposed on the upstream side of the head unit of each color, the units are arranged in such a manner as to face the conveying surface of the conveying belt, and the sensor for detecting the tip of the recording medium is disposed opposite to the conveying path on the conveying-direction downstream side of the lower surface of the maintenance unit or between the maintenance unit and the head unit. Accordingly, after the medium speed sufficiently follows the belt speed, the sensor detects the medium tip. Therefore, the positional shift of the image by the head unit (recording head) of each color can be minimized.

(6) The maintenance unit is disposed on the upstream side of the head unit of each color, and the units are disposed in such a manner as to face the conveying surface of the conveying belt. Accordingly, a distance from the auxiliary roller to the first recording head 9K lengthens, and the paper powder generated on the upstream side from the auxiliary roller is sucked into the chamber, and does not easily reach the head unit. As a result, non-discharge by the attached paper powder can be prevented.

Next, a second embodiment of the present invention will be described with reference to a schematic constitution example of FIG. 10.

In the present embodiment, a paper powder capturing section 20 is disposed on the lower surface of a maintenance unit 8.

This paper powder capturing section 20 comprises: a brush-shaped roller 20a which contacts a recording medium (recording sheet) surface to float paper powder adhering to the recording sheet surface; a duct suction port 20b disposed in the vicinity of the roller 20a to suck the paper powder; and a suction fan 20d connected to the duct suction port 20b via a tube 20c to suck the paper powder, and sucks air including the paper powder in the atmosphere from the duct suction port 20b.

By the paper powder capturing section 20, the paper powder generated from the recording sheet existing upstream or the remaining paper powder adhering to the recording sheet can be sucked and removed by the suction fan in the belt platen before reaching the head unit 9.

In the present embodiment, the brush-shaped roller 20a has been used in order to remove the paper powder adhering to the recording sheet. However, when the atmospheric air is only sucked via the suction port 20b without disposing the roller 20a, the effect is obtained.

Moreover, in the arrangement of constituting components in the present embodiment, the paper powder capturing section 20 (roller 20a) has been disposed under the maintenance unit 8, but may be disposed between the auxiliary roller 6 and the head unit 9. The maintenance unit 8 may be disposed on the downstream side of the auxiliary roller 6, and the capturing section may be disposed between the maintenance unit 8 and the head unit 9 downstream in order. Alternatively, the capturing section may be disposed between the auxiliary roller 6 and the maintenance unit 8.

When the capturing section is disposed on the downstream side of the maintenance unit 8 as in the present embodiment, a space for disposing the paper powder capturing section 20 (roller 20a) can be secured without enlarging a conveying surface size of the belt platen unit 7. The paper powder is sucked via the suction hole in the belt, and additionally dust floating in the vicinity of the recording medium is positively sucked. Accordingly, the nozzles can be prevented from being clogged. Moreover, when a brush roller contacts the sheet surface to remove the paper powder, the electrostatically adhering paper powder can be removed.

According to the second embodiment constituted as described above, the following function/effect can be obtained.

(1) The maintenance unit is disposed on the upstream side of the head unit of each color, the units are disposed in such a manner as to face the conveying surface of the conveying belt, and the paper powder capturing section is disposed opposite to the conveying path on the maintenance unit lower surface or between the maintenance unit and the head unit. Accordingly, the paper powder generated on the upstream side from the auxiliary roller is sucked by the paper powder capturing section, and does not easily reach the head unit (recording head). As a result, non-discharge by the attached paper powder can be reduced.

(2) Since the paper powder capturing section or the sheet tip detection sensor is disposed on the maintenance unit lower surface, the section or the sensor can be disposed facing the conveying surface without increasing the conveying length of the belt platen unit.

Next, a third embodiment will be described with reference to a constitution example of FIG. 13.

In the above-described first and second embodiments, a cut sheet has been described as a recording medium, but the present invention is not limited to the sheet. As shown in FIG. 13, a rolled/wound continuous sheet may be used in a recording apparatus. It is to be noted that a head unit 9 and a maintenance unit 8 have constitutions equivalent to those of the first embodiment. Here, a characteristic constitution will be described, other constituting components are denoted with the same reference numerals, and description thereof is omitted.

The image forming apparatus comprises a chamber 24 disposed facing the head unit 9 and the maintenance unit 8 and having a planar platen 25 attached on a facing side, and the belt 27 is omitted. Similarly as shown in FIG. 1, a large number of suction holes are made in the surface of the platen 25, and a negative pressure is generated by suction fans 26 disposed inside the chamber 24.

A continuous sheet 67 is conveyed to a roller 66 on a take-up side from a roller 65 on a supply/feed side via the upper surface of the platen 25 by a pair of conveying rollers 61, 62. The surfaces of the conveying roller 61 and a guide roller 63 are set at a height substantially equal to that of the platen upper surface, and the continuous sheet 67 adsorbed by the platen is conveyed.

By this constitution, a function/effect equivalent to that of the first embodiment can be obtained.

As described above, in the first and second embodiments, the belt conveying unit 7 is used as means disposed facing the head unit 9 to hold/convey the recording medium, but the present invention is not limited to this conveying mechanism. The means facing the head unit to support the recording medium may be a planar platen as in the third embodiment. Roller-shaped support means may be used as long as posture of the recording medium is determined while supporting the recording medium opposite to the head unit 9. The conveying means is not limited to the belt, and a pair of conveying rollers may be disposed on the upstream or downstream side of the support means.

According to the present invention, there can be provided an image forming apparatus in which a plurality of recording heads are arranged in the vicinity of one another, a maintenance unit is disposed in the vicinity of the recording heads in accordance with the arrangement of the recording heads, color difference in forming a color image accompanying the skewing of the recording medium is prevented, sufficient maintenance is realized, and the image is stably formed.

1. An image forming apparatus comprising: image forming means of an ink jet system; medium holding/conveying means disposed facing the image forming means to support a recording medium; and maintenance means for maintaining an ink discharge surface of the image forming means,
wherein the ink discharge surface of the image forming means and at least a part of the maintenance means are disposed facing the medium holding/conveying means, and the maintenance means is disposed on an upstream side of the image forming means in a conveying direction.

2. The image forming apparatus according to claim 1, wherein the image forming means is arranged by a unit of a plurality of rows of image forming means arranged in parallel in the conveying direction or by concentrated at a color unit.

3. The image forming apparatus according to claim 1, further comprising:
detection means for detecting an edge portion of the recording medium conveyed by the medium conveying means,
at least the detection means and the maintenance means being disposed facing the medium holding/conveying means on the upstream side of the image forming means in the conveying direction.

4. The image forming apparatus according to claim 1, further comprising:
means for removing dust from the recording medium conveyed by the conveying means or atmosphere around the recording medium,
at least the dust removing means and the maintenance means being disposed facing the medium holding/conveying means on the upstream side of the image forming means in the conveying direction.

5. The image forming apparatus according to claim 1, wherein the medium holding/conveying means is belt conveying means rotating around a suction chamber and having a suction hole.

6. The image forming apparatus according to claim 1, wherein the image forming means is a line head which is non-movable in at least a recording operation and by which the recording medium relatively moves with respect to the image forming means.

7. The image forming apparatus according to claim 1, further comprising: means for relatively moving the image forming means with respect to the medium holding/conveying means; and moving means for relatively inserting/detaching the maintenance means with respect to a space generated by the relative movement means.

8. An image forming apparatus comprising:
a recording medium holding/conveying unit which adsorbs and conveys a recording medium on a belt;
an image forming unit which faces the conveyed recording medium and in which head units constituted of a plurality of recording heads to discharge ink to the recording medium from a plurality of nozzles and form an image are arranged adjacent to one another and fixed; and
a maintenance unit which faces the belt on an upstream side in a conveying direction and which disposes the image forming unit facing the belt on a downstream side in the conveying direction and which moves ink discharge surfaces of the recording heads to maintain the ink discharge surfaces.

9. The image forming apparatus according to claim 8, wherein the recording head is provided with one nozzle row or two nozzle rows of the plurality of nozzles arranged to be shorter than a width of the recording medium,
the plurality of recording heads of the head units are alternately arranged in a direction crossing a medium conveying direction of the conveying unit at right angles in such a manner that the nozzle rows overlap with each other between the recording heads, and
the image forming unit comprises the head units as many as colors of the discharged ink, which are arranged adjacent to one another.

10. The image forming apparatus according to claim 8, wherein the recording medium holding/conveying unit of the image forming apparatus comprises the belt that has a large number of suction holes and rotatably extends around a housing in which a negative pressure generation source to generate a negative pressure is stored, and
the negative pressure generation source is disposed in a platen position facing at least the image forming unit and the maintenance unit, and the half of the suction holes of the belt on the platen position are closed by the recording medium when the recording medium reaches a position facing the image forming unit.

11. The image forming apparatus according to claim 8, wherein powder dust peeling means disposed in the vicinity of the maintenance unit or between the maintenance unit and the recording medium holding/conveying means to float powder dust sticking to the surface of the recording medium;
a suction port disposed on the downstream side from the powder dust peeling means in the conveying direction; and
suction means for sucking the powder dust from the suction port.
